(19) United States
(12) Patent Application Publication
(10) Pub. No.: US 2026/0338679 A1
(43) Pub. Date: Oct. 29, 2026

(54) Electrode Dryness Inspecting Device, Electrode Dryness Inspecting Method, and Method for Manufacturing Electrode and Secondary Battery

(71) Applicant: LG Energy Solution, Ltd., Seoul (KR)

(72) Inventors: Junghyoung Lee, Daejeon (KR); Sung Ho Lee, Daejeon (KR); Jin Young Son, Daejeon (KR); Won Chang Lee, Daejeon (KR); Hyeon Choi, Daejeon (KR)

(73) Assignee: LG Energy Solution, Ltd., Seoul (KR)

(21) Appl. No.: 19/491,099

(22) PCT Filed: Sep. 27, 2024
(86) PCT No.: PCT/KR2024/014721

§ 371 Date: Dec. 8, 2025

(30) Foreign Application Priority Data
Sep. 27, 2023 (KR) 10-2023-0130823
Sep. 26, 2024 (KR) 10-2024-0130870

(51) Int. Cl. G01N 21/3554; G01N 21/25; G01N 21/3563; G01N 21/359; H01M 10/42

(52) U.S. Cl. CPC G01N 21/3554; G01N 21/255; G01N 21/3563; G01N 21/359; H01M 10/4285

(57) ABSTRACT

A device for inspecting the dryness of an electrode may include a transport unit that transports the electrode to an electrode drying zone. The device may also include an irradiation unit including a collimating lens fixed in a range of 10 to 20 degrees relative to a direction perpendicular to a transport direction of the electrode at an upper part separated from the electrode. The irradiation unit may also include an optical fiber that irradiates a light source through the collimating lens. The device may also include a measurement unit including a spectrometer and a light source both connected to the irradiation unit. The measurement unit may also include a spectrometer hub connected to the spectrometer. The device may also include a control unit including a display device connected to the spectrometer hub.

### CROSS-REFERENCE TO RELATED APPLICATION(S)

The present application is a national phase entry under 35 U.S.C. § 371 of International Application No. PCT/KR2024/014721, filed on Sep. 27, 2024, which claims priority to and the benefit of Korean Patent Application No. 10-2023-0130823, filed on Sep. 27, 2023, and Korean Patent Application No. 10-2024-0130870, filed on Sep. 26, 2024, the disclosures of which are incorporated herein by reference in their entireties.

### TECHNICAL FIELD

The present disclosure relates to an electrode dryness inspecting device, an electrode dryness inspecting method, and a method for manufacturing an electrode and a secondary battery.

### BACKGROUND

As technologies for mobile devices are developed, and demand for the mobile devices increases, there has been a rapid increase in demand for secondary batteries as energy sources. In particularly, secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer, and a wearable device.

The secondary battery is manufactured by incorporating an electrode assembly together with an electrolyte in a secondary battery case, wherein the electrode assembly is manufactured by stacking and/or winding a positive electrode, a separator, and negative electrode.

At this time, the electrodes such as the positive electrode and the negative electrode are manufactured by mixing materials such as an active material, a conductive material, and a binder with a solvent to prepare a slurry, which is then applied to a current collector and dried. Here, the drying is performed by passing the electrode through a large number of drying zones. At this time, the degree of dryness of each electrode was evaluated by visually inspecting the constant rate section of each drying zone. However, since there are differences depending on each worker in this visual inspection, an objective judgment method was considered, and therefore, a measurement method utilizing the reflectance of the electrode was developed.

Evaluation of the degree of dryness through the electrode reflectance measurement is performed by comparing the reflectance of an electrode that has completely dried with that of an electrode that is being dried. However, according to a conventional electrode reflectance measurement method, the measurement angle changes due to shaking during the electrode drying running, while the effective measurement angle is extremely narrow in range to cause a lot of noise, which limits the accurate measurement of the degree of dryness of the electrode.

To explain this, FIG. 1 shows a schematic diagram of a portion of a conventional electrode reflectance measurement device, and FIG. 2 shows a graph of the BRDF (Bidirectional Reflectance Distribution Function) measurement result values measured using the conventional measurement device.

Referring to FIG. 1, the conventional electrode reflectance measuring device 10 is based on the concept of measuring a specular reflection, wherein the electrode 11 is transferred in the progress direction of coating, and an optical fiber 12(b) and a collimating lens 12(a) are located so that the light source is irradiated vertically at a predetermined distance (about 5 cm) based on the transfer direction of the electrode, thereby measuring the vertical reflectance. The sample that was completely dried was defined as having 100% reflectance, and then the electrode drying state is judged in two areas: specular reflection and diffuse reflection.

At this time, since the light source is irradiated in the vertical direction, the diameter of the collimating lens is set to about 5 mm.

However, referring to FIG. 2, it can be confirmed that the electrode reflectance measured by this measurement method has a very narrow range where the effective measurement angle is about ±0.7 degrees, but the measurement angle changes by an average of 2 degrees and a maximum of 4 degrees due to the shaking of the electrode when the coating linear speed increases, thereby making measurement very difficult.

Furthermore, when a specular reflection is used, wet electrodes that are not yet completely dried have the problem that incident light is absorbed or lost inside the electrode due to total internal reflection, and does not contribute to the reflectance.

Therefore, there is a need to develop a method that can resolve this problem and confirm the dryness without being affected by changes in a measurement angle caused by the occurrence of electrode shaking, as well as a method for manufacturing an electrode using the method.

### Technical Problem

The present disclosure is designed to solve the above-mentioned problems, and therefore an object of the present disclosure is to provide a device and method for inspecting an electrode dryness which uses diffuse reflection to eliminate the effects of changes in a measurement angle caused by electrode shaking during electrode drying and can inspect the drying state in real time through the reflectance of the electrode.

It is another object of the present disclosure to provide a method for manufacturing an electrode that can inspect the electrode dryness in real time and change the drying conditions by applying it, and a method for manufacturing a secondary battery including the same.

### Technical Solution

According to an aspect of the present disclosure, there is provided a device for inspecting the dryness of an electrode for a secondary battery, the device comprising:
a transport unit that transports the electrode to an electrode drying zone,
an irradiation unit including a collimating lens which is fixed in a state of being tilted by 10 to 20 degrees with respect to the direction perpendicular to the transport direction of the electrode at an upper part separated from the electrode, and an optical fiber that irradiates a light source through the collimating lens,
a measurement unit including a spectrometer and a light source respectively connected to the irradiation unit, and a spectrometer hub connected to the spectrometer, and
a control unit including a display device connected to the spectrometer hub.

According to another aspect of the present disclosure, there is provided a method for inspecting the degree of dryness of an electrode, in which:
when the electrode passes through the electrode drying zone, a light source is irradiated through a collimating lens that is tilted at an angle of 10 to 20 degrees with respect to a direction perpendicular to the transport direction of the electrode at an upper part separated from the electrode, the light intensity that the electrode reflects a light source is measured through a spectrometer, and the reflectance obtained from the following Equation 1 is measured in real time through a spectrometer hub based on the measured values to predict the degree of dryness of the electrode.

$$Reflectance = \frac{Measured Intensity - Dark Intensity}{Ref Intensity - Dark Intensity} * 100 \qquad [ Equation 1 ]$$

wherein in Equation 1,
the measured intensity is the total intensity reflected by the electrode when a light source is irradiated through the collimating lens from the upper part of the electrode,
the dark intensity is the lens reflection intensity obtained when a light source is irradiated to the collimating lens from the upper part of the electrode, and
the reference intensity is a value determined by a diffuse reflectance standard.

According to yet another aspect of the present disclosure, there is provided a method for manufacturing an electrode for a secondary battery, the method comprising:
a coating step of applying an electrode slurry containing an active material, a conductive material, and a binder to one surface or both surfaces of a current collector, and a step of drying the applied slurry,
wherein the drying is performed by transporting the undried electrode, on which the electrode slurry is applied onto one surface or both surfaces of the current collector, and passing it through the drying zone, and
wherein the drying is performed by measuring the electrode reflectance in real time using an irradiation unit including a collimating lens which is fixed in a state of being tilted by 10 to 20 degrees with respect to the direction perpendicular to the transport direction of the electrode at an upper part separated from the electrode formed in the drying zone, and an optical fiber that irradiates a light source through the collimating lens, and changing the electrode drying conditions.

According to yet another aspect of the present disclosure, there is provided a method for manufacturing a secondary battery comprising the method for manufacturing an electrode.

### BRIEF DESCRIPTION OF THE DRAWING

FIG. 1 is a schematic diagram of a portion of a conventional electrode reflectance measurement device.

FIG. 2 is a graph showing the BRDF measurement result values measured using the conventional measurement device of FIG. 1.

FIG. 3 is a schematic diagram of an electrode dryness inspecting device according to an aspect of the present disclosure.

FIG. 4 is a partial schematic diagram of an electrode dryness inspecting device of FIG. 3.

FIG. 5 is a BRDF measurement graph measured through the electrode dryness inspecting device of FIG. 3.

FIG. 6 is a graph of electrode reflectance measurement according to Example 1 of the present disclosure.

FIG. 7 is a schematic diagram showing electrode dryness according to the reflectance of FIG. 6.

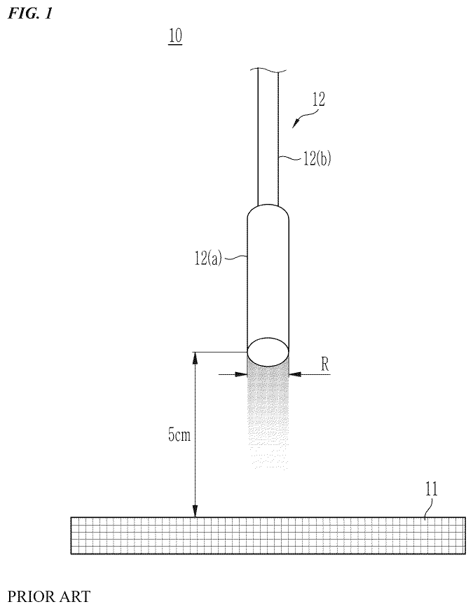

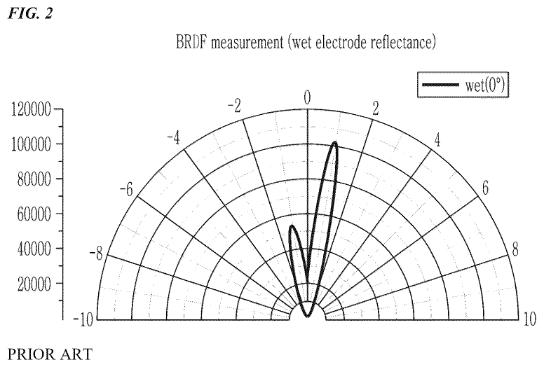

### DETAILED DESCRIPTION

Hereinafter, aspects of the present disclosure will be described in more detail to assist in understanding the present disclosure.

The terms used herein are provided to describe exemplary aspects but are not intended to limit the inventive concept. The singular forms include plural forms unless the context clearly indicates otherwise.

Throughout the descriptions herein, when a certain part “includes” a component, this does not indicate that the certain part excludes other components, but indicates that the part may further include other components, unless otherwise defined.

According to an aspect of the present disclosure, there is provided a device for inspecting the dryness of an electrode for a secondary battery, the device comprising:
a transport unit that transports the electrode to an electrode drying zone,
an irradiation unit including a collimating lens which is fixed in a state of being tilted 10 to 20 degrees with respect to the direction perpendicular to the transport direction of the electrode at an upper part separated from the electrode, and an optical fiber that irradiates a light source through the collimating lens,
a measurement unit including a spectrometer and a light source respectively connected to the irradiation unit, and a spectrometer hub connected to the spectrometer, and
a control unit including a display device connected to the spectrometer hub.

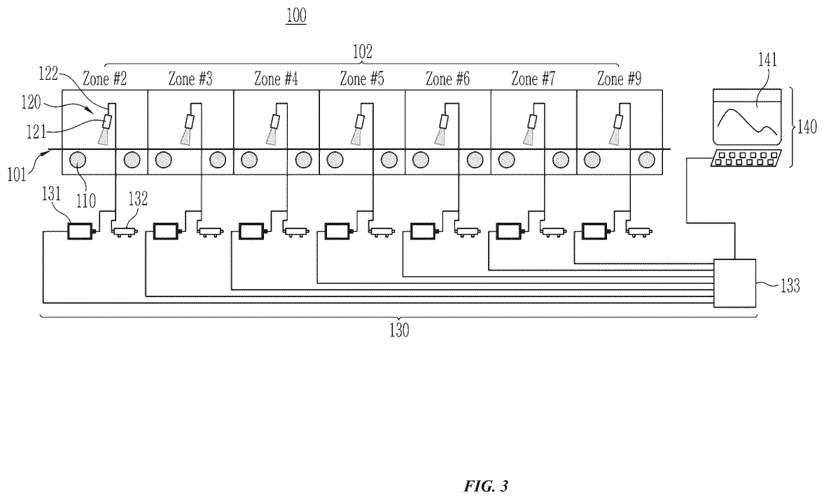

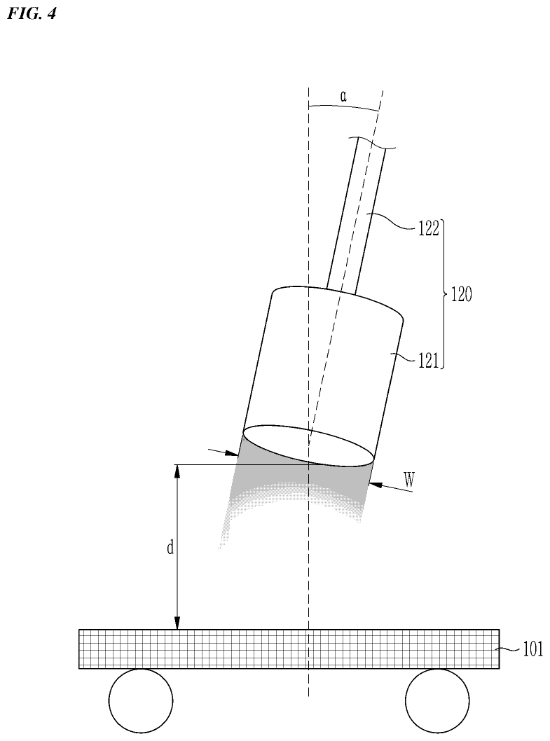

FIG. 3 shows a schematic diagram of such an electrode dryness inspecting device, and FIG. 4 shows a schematic diagram of a portion of the inspection device to explain in more detail the light source irradiation unit in such an electrode dryness inspecting device.

First, referring to FIG. 3, the electrode dryness inspecting device 100 includes a transport unit 110 that transports the electrode 101 to an electrode drying zone 102, an irradiation unit 120 including a collimating lens 121 which is fixed in a state of being tilted with respect to the direction perpendicular to the transport direction of the electrode 101 at an upper part separated from the electrode 101, and an optical fiber 122 that irradiates a light source through the collimating lens 121, a measurement unit 130 including a spectrometer 131 and a light source 132 respectively connected to the irradiation unit 120, and a spectrometer hub 133 connected to the spectrometer 131, and a control unit 140 including a display device 141 connected to the spectrometer hub 133.

Referring to FIG. 4, the irradiation unit 120 will be described in more detail.

According to the present disclosure, in the irradiation unit 120, the collimating lens 121 and the optical fiber 122 may be tilted at an angle(a) of 10 to 20 degrees with respect to the direction perpendicular to the transport direction of the electrode 101.

That is, according to the present disclosure, the light source is irradiated onto the electrode 101 in a state of being tilted at an angle of 10 to 20 degrees, and more specifically, the angle(a) of tilt may range from 10 to 15 degrees.

From the above, the present disclosure can calculate the electrode reflectance using only diffuse reflection other than specular reflection. Thereby, since the measurement itself is performed in a tilted state, it is not affected by changes in the measurement angle due to occurrence of shaking during electrode transport.

If it is tilted by less than 10 degrees outside the above range, specular reflection components may be detected, which may cause errors in the reflectance measurement, and if it is greater than the above range and exceeds 20 degrees, it is difficult to distinguish between the metal foil as the electrode current collector used in the electrode and the wet electrode, which is not preferable.

In this way, according to the present disclosure, the light source is irradiated at a tilted angle(a) to measure the reflectance, so that the electrode reflectance is measured in real time without being affected by the shaking of the electrode, thereby making it possible to easily and accurately inspect the degree of electrode dryness.

At this time, the collimating lens 121 irradiates the light source through the optical fiber in a tilted form, and thus can have a larger diameter(w), specifically 5 mm to 50 mm, more specifically 10 mm to 40 mm, and most specifically 10 mm to 20 mm.

If the diameter(w) is too small outside the above range, it is difficult to accurately measure the electrode reflectance because the light quantity is small, and if the diameter is too large, the light source irradiation range may become too wide, which is not preferable.

Further, the irradiation of the light source through the collimating lens 121 can be performed at a position separated from the electrode 101. Therefore, the distance(d) between the collimating lens 121 and the electrode 101 may range from 3 cm to 10 cm, specifically from 3 cm to 5 cm.

If the distance(d) is too close outside the above range, physical interference with the electrode during the process may occur, which may result in electrode breakage problems, and if the distance is too far, the light source range may be too wide, thereby making it difficult to accurately irradiate the desired area, which is not preferable.

Furthermore, although not shown in the figure, the collimating lens 121 may have an anti-reflective(AR) coating lens formed on its surface. If the anti-reflective coating lens is not formed, lens reflection may increase, and a large amount of reflectance noise may occur in the wet electrode, which is not preferable.

At this time, the wavelength range of the anti-reflective(AR) coating lens may range from 680 nm to 1050 nm, and the average reflectance may be 0.5% or less.

Although it is outside the above range, the thickness of such an anti-reflective coating lens can be appropriately selected taking into account the diameter of the collimating lens. The wavelength range is influenced by the irradiation of the light source through the optical fiber 122 and is selected to correspond to the wavelength range of the optical fiber. If the reflectance is large outside the above range, it is difficult to sufficiently remove the reflection component of the collimating lens, which is not preferable.

Meanwhile, the optical fiber 122 that irradiates the light source through the collimating lens 121 may have an average diameter of 200 μm to 800 μm, specifically, 400 μm to 800 μm, more specifically, 500 μm to 800 μm, and most specifically, 600 μm to 800 μm.

If the average diameter is small outside the above range, the light quantity may be too small, which may make it difficult to measure the reflectance, and if the average diameter is too large, manufacturing and efficiency may be problematic.

In addition, the light source power varies depending on the device, and for example, it can be irradiated in the range of 5 W to 200 W, and the lifetime is preferably 2000 hours or more. At this time, if the power of the light source device itself is not high, the light quantity can be increased by increasing the diameter of the optical fiber to about 600 μm, thereby measuring the electrode reflectance.

As another important factor, the light wavelength range of the optical fiber can be 680 nm to 1050 nm. The wavelength corresponds to a wavelength corresponding to near-infrared rays, and the wavelength range is not limited, but when the electrode 101 passes through the drying zone 102, a situation may often occur where a window or door is opened for visual confirmation by workers. Thus, when using light with a wavelength value in the visible light range, the electrode reflectance may be affected by interference from external light, so it is most preferable to use it in the near-infrared range so as not to affect such external light.

Referring again to FIG. 3, this irradiation unit 120 is connected to a spectrometer and a light source, and the spectrometer measures the reflectance of the electrode according to the light source irradiation, and the resulting value is displayed on the display device 141.

At this time, in general, in order to inspect the degree of dryness of the electrode 101, it is important to know how much degree of dryness of the electrode is appeared when passing through the drying furnace, that is, at the end part of the drying oven when drying is complete. Therefore, it is preferable that the irradiation unit 120 of the main inspection device 100 is formed at the end of the electrode drying zone 102.

Meanwhile, drying of the electrode 101 manufactured in actual mass production is not completed by passing through one drying zone, but is sequentially dried while passing through multiple drying zones.

Therefore, two or more electrode drying zones 102 may be formed in the transport direction of the electrode 101. The electrode dryness inspecting device 100 according to the present disclosure measures the reflectance of each of the drying zones #2 to #9, and determines the degree of dryness of the electrode as it passes through each drying zone. For this purpose, two or more irradiation units including a collimating lens 121 and an optical fiber 122, a spectrometer 131 and a light source 131 are respectively separated and formed at the end of each drying zone, and the values obtained from these are displayed in real time on the control unit via the spectrometer hub, which makes it possible to confirm the drying state of the electrodes in real time, thereby making drying design easy.

Meanwhile, according to another aspect of the present disclosure, a method for inspecting the degree of dryness of an electrode using the inspection device is provided.

Specifically, when the electrode passes through the electrode drying zone, a light source is irradiated through a collimating lens that is tilted at an angle of 10 to 20 degrees with respect to a direction perpendicular to the transport direction of the electrode at an upper part separated from the electrode, the light intensity obtained therefrom is measured through a spectrometer, and the reflectance obtained from the following Equation 1 is measured in real time through a spectrometer hub based on the measured values to predict the degree of dryness of the electrode.

$$Reflectance = \frac{Measured Intensity - Dark Intensity}{Ref Intensity - Dark Intensity} * 100 \qquad [ Equation 1 ]$$

wherein in Equation 1,
the measured intensity is the total intensity reflected by the electrode when a light source is irradiated through the collimating lens from the upper part of the electrode,
the dark intensity is the lens reflection intensity obtained when a light source is irradiated to the collimating lens from the upper part of the electrode, and
the reference intensity is a value determined by a diffuse reflectance standard.

That is, according to the electrode dryness inspecting method of the present disclosure, as described in the inspection device, when a light source is irradiated through a collimating lens, the collimating lens and the optical fiber are fixed and installed at a specific angle to measure the electrode reflectance by diffuse reflection, and the degree of electrode dryness is predicted from this.

At this time, the electrode reflectance is calculated by the method of the Equation 1, and is displayed in real time to the control unit through the spectrometer hub.

Specifically, the electrode reflectance can be calculated from the value obtained by subtracting the dark intensity from the total light irradiation intensity measured by irradiation with the light source.

Here, the dark intensity is generally a value obtained in a state where the light source is turned off, whereas according to the present disclosure, it is intended to remove components reflected by the collimating lens itself, and is a value measured by setting the tilt value to 10 degrees or more in a state where the light source is turned on. Specifically, in a state where the light source is turned on, that is, in a state where the light source is irradiated on the collimating lens, the dark intensity is a lens reflection intensity obtained by the reflection, which is a value measured from a tilt value of 10 degrees or more, specifically in the range of 10 degrees to 20 degrees.

From this, the reflectance of the electrode of the present disclosure is obtained as a percentage value obtained by dividing the light intensity obtained from the actual electrode by the reference intensity minus the dark intensity.

The BRDF graph measured in this way is shown in FIG. 5 below.

Referring to FIG. 5, the reflectance value obtained by the reflectance measurement value through diffuse reflection according to the present disclosure has a very wide effective angle of 20 degrees, and the reflectance measured according to the present disclosure is not affected by the degree of change in the measurement angle due to the shaking caused by the transport of the electrode, thereby being able to be obtained reliably.

Here, the reference intensity (Ref Intensity) can be specifically a value obtained from Ocean Insight, WS-1-SL using a standard sample with a Diffuse Reflectance of 99% (Nominal Reflectance, 350-1600 nm) and an NIST (National Institute of Standards and Technology) certified sample.

Meanwhile, the device-related explanations for other collimating lenses, optical fibers, etc. are as described above.

Further, the electrode dryness inspecting method of the present disclosure can also predict the degree of dryness from the reflectance obtained at the end of the drying zone, wherein the drying zone is formed by two or more zones, and the reflectance is measured at the end of each drying zone, whereby the degree of electrode dryness when passing through each drying zone can be predicted, thereby making it possible to easily design a drying process.

Meanwhile, according to another aspect of the present disclosure, a method for manufacturing an electrode for a secondary battery using the electrode dryness inspecting method is provided.

Specifically, the method for manufacturing an electrode for a secondary battery, the method comprising:
a coating step of applying an electrode slurry containing an active material, a conductive material, and a binder to one surface or both surfaces of a current collector, and a step of drying the applied slurry,
wherein the drying is performed by transporting the undried electrode, on which the electrode slurry is applied onto one surface or both surfaces of the current collector, and passing it through the drying zone, and
wherein the drying is performed by measuring the electrode reflectance in real time using an irradiation unit including a collimating lens which is fixed in a state of being tilted by 10 to 20 degrees with respect to the direction perpendicular to the transport direction of the electrode at an upper part separated from the electrode formed in the drying zone, and an optical fiber that irradiates a light source through the collimating lens, and changing the electrode drying conditions.

In this case, as described in the electrode dryness inspecting method, the electrode reflectance is obtained by measuring the light intensity reflected by the electrode from the light source irradiated by the optical fiber through a spectrometer, and obtained from the following Equation 1 through a spectrometer hub based on the measured values:

$$Reflectance = \frac{Measured Intensity - Dark Intensity}{Ref Intensity - Dark Intensity} * 100 \qquad [ Equation 1 ]$$

wherein in Equation 1,
the measured intensity is the total intensity reflected by the electrode when a light source is irradiated through the collimating lens from the upper part of the electrode,
the dark intensity is the lens reflection intensity obtained when a light source is irradiated to the collimating lens from the upper part of the electrode, and
the reference intensity is a value determined by a diffuse reflectance standard.

Therefore, the electrode manufactured according to an aspect of the present disclosure can measure the electrode reflectance in real time, and thus the degree of electrode dryness when passing through each drying zone can be predicted, so that the electrode drying conditions within the drying zone can be easily changed and set, which makes it more effective for electrode drying.

Therefore, the electrode reflectance of the electrode manufactured according to this, that is, the electrode after drying, may range from 10% or more, and specifically, 10% to 20%. This means that the electrode is completely dried inside, and there may be an error of several percent depending on the electrode material.

In conclusion, the electrode manufactured by the method according to the present disclosure can also improve its quality by sufficiently drying the electrode.

Meanwhile, according to yet another aspect of the present disclosure, a method for manufacturing a secondary battery comprising an electrode manufactured by the method is provided.

Except for the above electrode manufacturing method, the subsequent secondary battery manufacturing process may include a method disclosed in the prior art.

### EXAMPLES

Below, examples are disclosed to assist in understanding the present disclosure. Specifically, the method of measuring the reflectance using a dryness inspecting device according to the present disclosure and predicting the degree of electrode dryness from the reflectance graph is explained with reference to Experimental Examples. However, the following examples are for illustrative purposes only, and the scope of the present disclosure is not limited thereto

### Manufacturing Example 1

Artificial graphite, binder(SBR), and thickener(CMC) were mixed in a weight ratio of 95:3:2 to prepare a slurry under deionized water, and the slurry was applied to a copper foil to a thickness of 300 μm to manufacture a wet electrode 1.

### Manufacturing Example 2

Artificial graphite, binder(SBR), and thickener(CMC) were mixed in a weight ratio of 96:2:2 to prepare a slurry under deionized water, and the slurry was applied to a copper foil to a thickness of 300 μm to manufacture a wet electrode 2.

### Manufacturing Example 3

Artificial graphite, binder(SBR), and thickener(CMC) were mixed in a weight ratio of 97:2:1 to prepare a slurry under deionized water, and the slurry was applied to a copper foil to a thickness of 300 μm to manufacture a wet electrode 3.

### Experimental Example

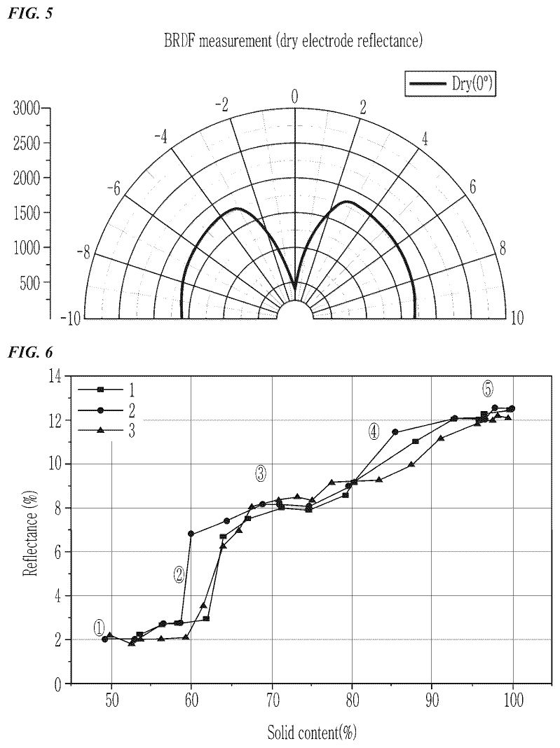

And, while passing the wet electrodes 1 to 3 through multiple drying zones as shown in FIG. 3, the electrode drying reflectance was measured at the end of each drying zone by the method according to the present disclosure, and the results are shown in FIG. 6.

Referring to FIG. 6, it can be confirmed that the reflectance of the electrode is divided into a flat section \textcircled{1} where the value is constant from the start of electrode drying, an acceleration section \textcircled{2} where the value increases rapidly, a lull section \textcircled{3} where the slope decreases again and the change is small, an additional acceleration section \textcircled{4} where the slope increases again, and a completion section \textcircled{5} where the reflectance change is almost nonexistent.

From this graph, the dryness of the electrode can be predicted from the moisture content in five stages: from a wet state to a state where the surface is dried, a state where the surface drying is completed, a state where the inside is dried, and a state where the inside drying is completed.

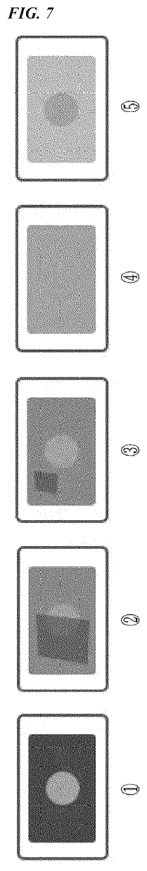

In order to show the degree of dryness so as to correspond to the above graph, FIG. 7 shows a schematic diagram of the degree of electrode dryness.

That is, the flat section \textcircled{1} where the electrode reflectance is constant corresponds to a state where drying has begun and the electrode is still wet, the acceleration section \textcircled{2} where the reflectance increases rapidly corresponds to a state where the electrode surface is dried, the lull section \textcircled{3} where the slope decreases and the change is small corresponds to a state where surface drying is almost completed and the change in the value is small, the additional acceleration section \textcircled{4} where the slope increases again corresponds to a state where internal drying has begun and internal drying is taking place, and the completion section \textcircled{5} where there is little change in reflectance corresponds to a state where not only the surface but also the interior has been completely dried. From this, it is possible to reliably predict the degree of electrode dryness and facilitate the design of the drying process.

It will be apparent to those skilled in the art that various modifications and variations can be made in the present disclosure without departing from the spirit and scope of the present disclosure.

### INDUSTRIAL APPLICABILITY

The electrode dryness inspecting device and method according to the aspects can maintain a constant reflectance even if the measurement angle fluctuates in the reflectance measurement by using only diffuse reflection, which eliminates the influence of angular shaking during electrode transport, and measures the electrode reflectance in real time, thereby easily confirming the electrode dryness state.

In addition, the method for manufacturing an electrode according to the present disclosure can easily confirm the electrode drying state in real time via the electrode reflectance, and thus can dry the electrode while changing electrode drying conditions, thereby increasing drying efficiency and improving the quality of the electrode where drying was completed.

1. A device for inspecting the dryness of an electrode for a secondary battery, the device comprising:
a transport unit configured to transport the electrode in a transport direction to an electrode drying zone,
an irradiation unit including:
a collimating lens tilted in a range from 10 to 20 degrees from a direction perpendicular to the transport direction of the electrode, the collimating lens positioned above and separated from the electrode when transported in the transport direction, and
an optical fiber configured to irradiate a light source through the collimating lens,
a measurement unit including:
a spectrometer and a light source both connected to the irradiation unit, and
a spectrometer hub connected to the spectrometer, and
a control unit including a display device connected to the spectrometer hub.

2. The device for inspecting the dryness of an electrode according to claim 1, wherein the collimating lens has a diameter ranging from 5 mm to 50 mm and is located in a range from 3 cm to 10 cm apart from the electrode.

3. The device for inspecting the dryness of an electrode according to claim 1, wherein the collimating lens includes an anti-reflective(AR) coating lens on its surface,
wherein a wavelength of the anti-reflective coating lens ranges from 680 nm to 1050 nm, and the
wherein an average reflectance is 0.5% or less.

4. The device for inspecting the dryness of an electrode according to claim 1, wherein an average diameter of the optical fiber ranges from 200 μm to 800 μm, and
wherein an optical wavelength of the optical fiber ranges from 680 nm to 1050 nm.

5. The device for inspecting the dryness of an electrode according to claim 1, wherein the spectrometer is configured to measure a reflectance from the electrode and transmit the reflectance from the electrode to the spectrometer hub, and
wherein the display device is configured to display the reflectance from the electrode in real time through the spectrometer hub.

6. The device for inspecting the dryness of an electrode according to claim 1, wherein the irradiation unit is positioned at an end of the electrode drying zone.

7. The device for inspecting the dryness of an electrode according to claim 1, wherein the electrode drying zone includes a plurality of electrode drying zones in the transport direction of the electrode,
further including a plurality of irradiation units, each irradiation unit of the plurality of irradiation units being positioned at an end of a respective one of the plurality of drying zones.

8. A method for inspecting the degree of dryness of an electrode, the method comprising:
irradiating light, using a light source through a collimating lens, when the electrode passes through an electrode drying zone, wherein the collimating lens is tilted at an angle ranging from of 10 to 20 degrees with respect to a direction perpendicular to a transport direction of the electrode and is located above and separated from the electrode when transported along the transport direction,
measuring a light intensity that the electrode reflects the light source using a spectrometer, and
calculating a reflectance measurement using Equation 1 in real time through a spectrometer hub based on the measured light intensity; and
predicting, based on the calculated reflectance, the degree of dryness of the electrode,
$$Reflectance = \frac{Measured Intensity - Dark Intensity}{Ref Intensity - Dark Intensity} * 100 \qquad [ Equation 1 ]$$
wherein in Equation 1,
the measured intensity is a total light intensity reflected by the electrode when the light source is irradiated through the collimating lens from above the electrode,
the dark intensity is a lens reflection intensity obtained when the light source is irradiated to the collimating lens from above the electrode, and
the reference intensity is a value determined by a diffuse reflectance standard.

9. The method according to claim 8, wherein the collimating lens includes an anti-reflective(AR) coating lens on its surface,
wherein the collimating lens has a diameter ranging from 5 mm to 50 mm, and
wherein the collimating lens is located in a state range from 3 cm to 10 cm apart from the electrode.

10. The method according to claim 9, wherein a wavelength of the anti-reflective coating lens ranges from 680 nm to 1050 nm, and the
wherein a reflectance is an average of 0.5% or less.

11. The method according to claim 8, wherein irradiating light using the light source is through an optical fiber having an average diameter ranging from 200 μm to 800 μm and an optical wavelength ranging from 680 nm to 1050 nm.

12. The method according to claim 8, wherein irradiating light using the light source and calculating the reflectance measurement are performed at an end of the electrode drying zone.

13. The method for inspecting the degree of dryness of an electrode according to claim 12, wherein the electrode drying zone includes a plurality of electrode drying zones in the transport direction of the electrode,
wherein the reflectance is measured for each electrode drying zone of the plurality of electrode drying zones.

14. A method for manufacturing an electrode for a secondary battery, the method comprising:
applying an electrode slurry containing an active material, a conductive material, and a binder to at least one surface of a current collector to form an undried electrode, and
drying the applied slurry including:
transporting an undried electrode, and
passing the undried electrode through an electrode drying zone, and
measuring a reflectance in real time using an irradiation unit including a collimating lens tilted at an angle ranging from 10 to 20 degrees with respect to a direction perpendicular to a transport direction of the electrode, wherein the collimating lens is positioned above and separated from the electrode in the electrode drying zone, and
irradiating light through an optical fiber and the collimating lens of a light source, and
changing the electrode drying conditions.

15. The method for manufacturing an electrode according to claim 14, further comprising measuring the reflectance based on a light intensity reflected by the electrode from the light source irradiated by the optical fiber through a spectrometer, and
calculating a reflectance from the following Equation 1 through a spectrometer hub based on the measured light intensity,
$$Reflectance = \frac{Measured Intensity - Dark Intensity}{Ref Intensity - Dark Intensity} * 100 \qquad [ Equation 1 ]$$
wherein the measured intensity is a total light intensity reflected by the electrode when a light source is irradiated through the collimating lens from above the electrode,
the dark intensity is the lens reflection intensity obtained when the light source is irradiated to the collimating lens from above of the electrode, and
the reference intensity is a value determined by a diffuse reflectance standard.

16. The method for manufacturing an electrode according to claim 14, wherein the electrode drying zone includes a plurality of electrode drying zones in the transport direction of the electrode.

17. The method for manufacturing an electrode according to claim 14, wherein then the drying is completed, the reflectance is 10% or more.

18. A method for manufacturing a secondary battery comprising the method for manufacturing an electrode according to claim 14.
